(19) United States
(12) Patent Application Publication
(10) Pub. No.: US 2025/0313753 A1
(43) Pub. Date: Oct. 9, 2025

(54) LIQUID CRYSTAL MATERIAL COMPOSITION AND DISPLAY DEVICE

(71) Applicant: Japan Display Inc., Tokyo (JP)

(72) Inventors: Yasushi IWAKABE, Tokyo (JP); Koichi IGETA, Tokyo (JP)

(73) Assignee: Japan Display Inc., Tokyo (JP)

(21) Appl. No.: 19/097,962

(22) Filed: Apr. 2, 2025

(30) Foreign Application Priority Data
Apr. 3, 2024 (JP) 2024-060236

(51) Int. Cl. C09K 19/20; C09K 19/12; C09K 19/54; G02F 1/1337

(52) U.S. Cl. CPC C09K 19/2007; C09K 19/12; C09K 19/542; C09K 2019/122; C09K 2019/123; C09K 2019/2035; C09K 2019/2042; C09K 2019/2078; G02F 1/13378

(57) ABSTRACT

According to one embodiment, the monomer mixture includes a first monomer compound having acryloyl group at each terminal and a second monomer compound having acryloyl group at only one terminal.

### CROSS-REFERENCE TO RELATED APPLICATIONS

This application is based upon and claims the benefit of priority from Japanese Patent Application No. 2024-060236, filed Apr. 3, 2024, the entire contents of which are incorporated herein by reference.

### FIELD

Embodiments described herein relate generally to a liquid crystal material composition and a display device.

### BACKGROUND

Recently, various types of illumination devices employing polymer dispersed liquid crystal (hereinafter often referred to as “PDLC”) capable of switching a scattering state of scattering incident light beams and a transparent state of transmitting incident light beams have been proposed. Such display devices have high transmittances and thus are expected to have uses in many industries. Improvement of display quality in such display devices has been demanded.

### BRIEF DESCRIPTION OF THE DRAWINGS

FIG. 1 is a plan view showing a configuration example of a display device DSP of the present embodiment.

FIG. 2 is a cross-sectional view showing a configuration example of the display device DSP shown in FIG. 1.

FIG. 3 is a diagram showing an example of a manufacturing method of the display panel PNL shown in FIG. 1.

FIG. 4 is a diagram showing an example of the manufacturing method of the display panel PNL shown in FIG. 1.

### DETAILED DESCRIPTION

In general, according to one embodiment, a liquid crystal material composition includes a liquid crystal mixture, a polymerization initiator, and a monomer mixture. The monomer mixture contains a first monomer compound having acryloyl group at each terminal and a second monomer compound having acryloyl group at only one terminal. This configuration can provide a liquid crystal material composition capable of suppressing degradations in display quality and a display device capable of suppressing degradations in display quality.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements which function in the same or a similar manner to those described in connection with preceding drawings are denoted by like reference numbers, detailed description thereof being omitted unless necessary.

### <Display Device>

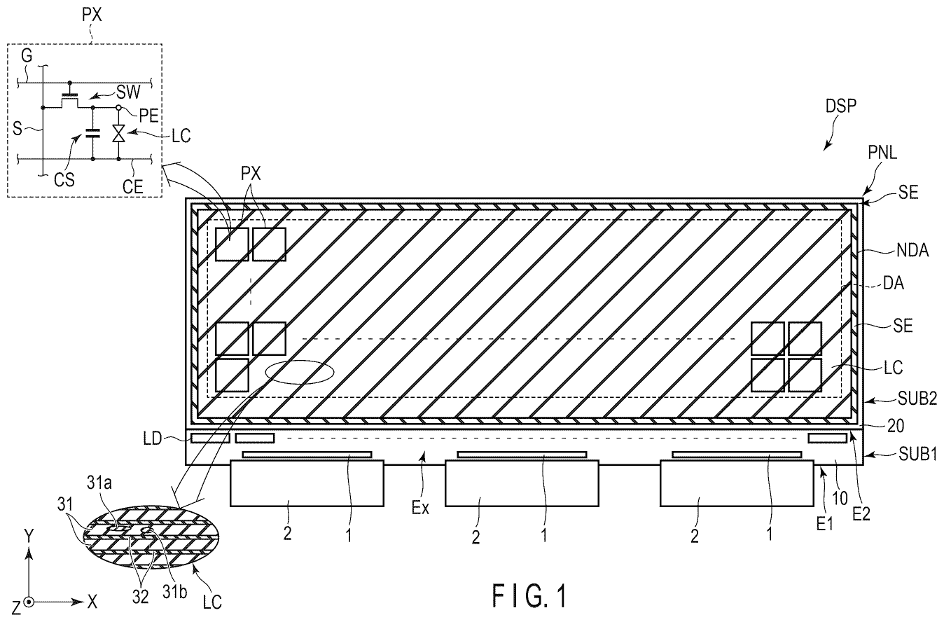

FIG. 1 is a plan view showing a configuration example of a display device DSP of the present embodiment. For example, a first direction X, a second direction Y, and a third direction Z are orthogonal to each other but may intersect at an angle other than 90 degrees. The first direction X and the second direction Y correspond to the directions parallel to the main surface of a substrate that constitutes the display device DSP, and the third direction Z corresponds to the thickness direction of the display device DSP. In the present specification, a direction from a first substrate SUB1 to a second substrate SUB2 is referred to as an upward direction (or, more simply, upwardly) and a direction from the second substrate SUB2 to the first substrate SUB1 is referred to as a downward direction (or, more simply, downwardly). According to “a second member on/above a first member” and “a second member under/below a first member”, the second member may be in contact with the first member or may be spaced apart from the first member. In addition, an observation position at which the display device DSP is observed is assumed to be located on the distal side of the arrow indicating the third direction Z, and viewing from the observation position toward the X-Y plane defined by the first direction X and the second direction Y is referred to as a plan view.

The display device DSP of the present embodiment employs polymer dispersed liquid crystal. The display device DSP comprises a display panel PNL, an IC chip 1, a wiring board 2, a light emitting element LD, and a light guide element LG. FIG. 1 omits illustration of the light guide element LG.

The display panel PNL comprises the first substrate SUB1, the second substrate SUB2, a liquid crystal layer LC, and a seal SE. The first substrate SUB1 and the second substrate SUB2 are each formed into a flat plate shape parallel to the X-Y plane. The first substrate SUB1 and the second substrate SUB2 overlap in plan view. The first substrate SUB1 and the second substrate SUB2 are bonded together by the seal SE.

The liquid crystal layer LC is held between the first substrate SUB1 and the second substrate SUB2 and is sealed by the seal SE. FIG. 1 shows the liquid crystal layer LC and the seal SE by different oblique lines.

As shown in enlarged and schematic manner in FIG. 1, the liquid crystal layer LC comprises polymer dispersed liquid crystal containing polymers 31 and liquid crystal mixtures 32. As described later, the polymer 31 is derived from a monomer mixture containing a first monomer compound having acryloyl group at each terminal and a second monomer compound having acryloyl group at only one terminal. The polymer 31 contains a polymer 31a mainly derived from the first monomer compound, and a polymer 31b mainly derived from the second monomer compound. As described later, the liquid crystal mixture 32 contains at least a type of a first liquid crystal compound, at least a type of a second liquid crystal compound, and at least a type of a third liquid crystal compound.

In the example shown in FIG. 1, the polymers 31 are formed into a stripe shape extending along the first direction X. The liquid crystal mixtures 32 are dispersed in gaps between the polymers 31 and are arranged such that longitudinal axes of the liquid crystal mixtures 32 are along the first direction X. Each of the polymers 31 and the liquid crystal mixtures 32 has optical anisotropy or refractive anisotropy. The response performance of the polymers 31 to the electric field is lower than the response performance of the liquid crystal mixtures 32 to the electric field.

For example, the alignment direction of the polymers 31 hardly varies regardless of the presence or absence of the electric field. In contrast, in a state where a voltage higher than or equal to the threshold value is applied to the liquid crystal layer LC, the alignment direction of the liquid crystal mixtures 32 varies in accordance with the electric field. When no voltage is applied to the liquid crystal layer LC, the optical axes of the polymers 31 are parallel to those of the liquid crystal mixtures 32, and light beams made incident on the liquid crystal layer LC are transmitted substantially without being scattered inside the liquid crystal layer LC (the transparent state). When a voltage is applied to the liquid crystal layer LC, the optical axes of the polymers 31 intersect those of the liquid crystal mixtures 32, and light beams made incident on the liquid crystal layer LC are scattered inside the liquid crystal layer LC (the scattering state). The liquid crystal layer LC is formed of liquid crystal material compositions to be described later.

The display panel PNL comprises a display portion DA, which displays images and a non-display portion NDA, which has a frame shape and surrounds the display portion DA, in an area where the first substrate SUB1 and the second substrate SUB2 overlap. The seal SE is located in the non-display portion NDA. The display portion DA comprises a plurality of pixels PX arranged in a matrix in the first direction X and the second direction Y.

In addition, the first substrate SUB1 includes an edge portion E1 extending along the first direction X. In addition, the second substrate SUB2 includes an edge portion E2 extending along the first direction X. The edge portion E2 and the edge portion E1 do not overlap in plan view. The first substrate SUB1 includes an extending portion Ex extending from the edge portion E2 along the second direction Y in plan view. The extending portion Ex and the second substrate SUB2 do not overlap in plan view.

The light emitting element LD is connected to the wiring board 2. The light emitting elements LD are arranged in the first direction X at intervals and overlap the extending portion Ex in plan view. The light emitting elements LD are, for example, light emitting diodes. Though not described in detail, the light emitting element LD comprises a red light emitting portion, a green light emitting portion, and a blue light emitting portion.

As shown in enlarged manner in FIG. 1, each pixel PX comprises a switching element SW, a pixel electrode PE, a common electrode CE, a liquid crystal layer LC, and the like. The switching element SW is constituted by, for example, a thin-film transistor (TFT) and is electrically connected to a scanning line G and a signal line S. The scanning line G extends in the first direction X, and is electrically connected to the switching element SW of each of the pixels PX arranged in the first direction X. The signal line S extends in the second direction Y, intersects the scanning line G, and is electrically connected to the switching element SW of each of the pixels PX arranged in the second direction Y. The pixel electrode PE is electrically connected to the switching element SW. Each pixel electrode PE faces the common electrode CE and drives the liquid crystal layer LC by an electric field produced between the pixel electrode PE and the common electrode CE. A capacitor CS is formed, for example, between the common electrode CE and an electrode having the same electric potential as the common electrode CE and between the pixel electrode PE and an electrode having the same potential as the pixel electrode PE.

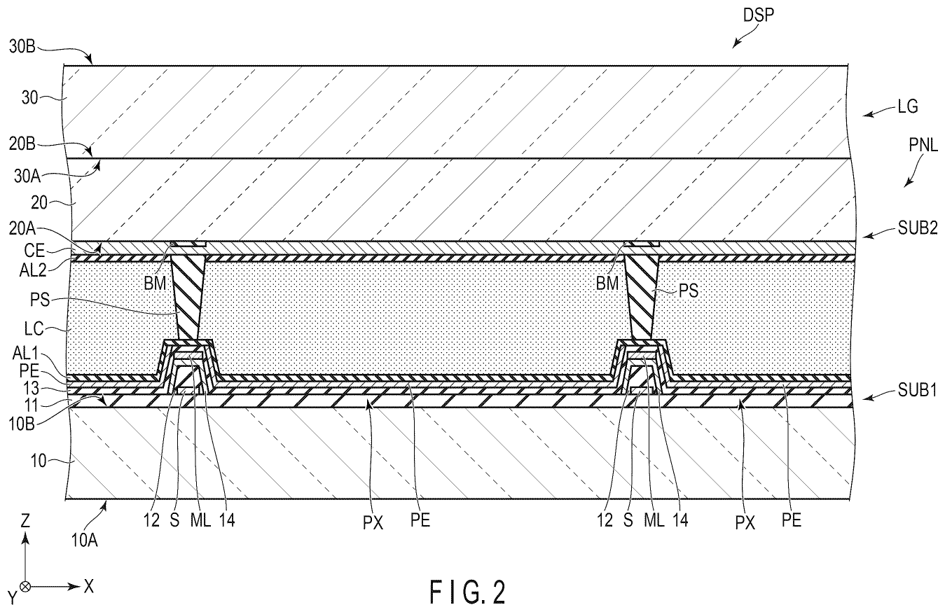

FIG. 2 is a cross-sectional view showing a configuration example of the display device DSP shown in FIG. 1. The following describes the cross section of the display portion DA of the X-Z plane defined by the first direction X and the third direction Z.

The first substrate SUB1 comprises a transparent substrate 10, insulating films 11, 12, and 13, a capacitive electrode 14, a metal line ML, the signal line S, the pixel electrode PE, and an alignment film AL1. The first substrate SUB1 further comprises the switching element SW and the scanning line G shown in FIG. 1.

The transparent substrate 10 comprises a main surface (lower surface) 10A and a main surface (upper surface) 10B on the side opposite to the main surface 10A. The insulating film 11 covers the main surface 10B. The signal line S is formed on the insulating film 11. For example, the scanning line G is provided between the transparent substrate 10 and the insulating film 11. The insulating film 12 covers the signal line S. Though not described in detail, the insulating film 12 is formed into a lattice shape overlapping the scanning line G and the signal line S. The capacitive electrode 14 is provided on the insulating film 12. The metal line ML is provided on the capacitive electrode 14. Though not described in detail, the capacitive electrode 14 and the metal line ML are formed into a lattice shape overlapping the insulating film 12.

The insulating film 13 covers the insulating film 11, the capacitive electrode 14, and the metal line ML. The capacitive electrode 14 is provided between the insulating films 12 and 13. The pixel electrode PE is provided between the insulating film 13 and the alignment film AL1, in each pixel PX. The pixel electrode PE is electrically connected to the switching element SW. The pixel electrode PE overlaps the capacitive electrode 14 to form the capacitor CS of the pixel PX through the insulating film 13. The first alignment film AL1 covers the pixel electrode PE and the insulating film 13.

The second substrate SUB2 comprises a transparent substrate 20, a light-shielding layer BM, the common electrode CE, an alignment film AL2, and a spacer PS.

The transparent substrate 20 comprises a main surface (lower surface) 20A and a main surface (upper surface) 20B on the side opposite to the main surface 20A. The main surface 20A of the transparent substrate 20 faces the main surface 10B of the transparent substrate 10 and the alignment film AL1.

For example, the light-shielding layer BM is provided between the main surface 20A and the common electrode CE. The common electrode CE covers the main surface 20A and the light-shielding layer BM. The spacer PS is arranged on a surface facing the liquid crystal layer LC of the common electrode CE, passes through the liquid crystal layer LC, and contacts the alignment film AL1. The alignment film AL2 covers the common electrode CE.

The alignment films AL1 and AL2 are horizontal alignment films having an alignment restriction force substantially parallel to the X-Y plane. For example, the alignment films AL1 and AL2 are subjected to alignment treatment along the first direction X. The alignment treatment may be a rubbing treatment or an optical alignment treatment.

The liquid crystal layer LC may be provided between the alignment film AL1 and the second substrate SUB2. The liquid crystal layer LC in the example shown in FIG. 2 contacts the alignment films AL1 and AL2.

The light guide element LG comprises a transparent substrate 30. The transparent substrate 30 comprises a main surface (lower surface) 30A and a main surface (upper surface) 30B on the side opposite to the main surface 30A. The main surfaces 30A and 30B are the surfaces substantially parallel to the X-Y plane. The main surface 30A faces the main surface 20B of the transparent substrate 20. The transparent substrate 30 is bonded to the transparent substrate 20.

The configurations of the display device DSP and the display panel PNL are not limited to the examples in FIG. 1 and FIG. 2. For example, the display device DSP may not comprise the light guide element LG.

### <Liquid Crystal Material Composition>

The liquid crystal layer LC described above is formed of the liquid crystal material composition. The liquid crystal material composition includes the liquid crystal mixture, a polymerization initiator, and the monomer mixture.

### (Liquid Crystal Mixture)

The liquid crystal mixture includes at least a type of the first liquid crystal compound, at least a type of the second liquid crystal compound, and at least a type of the third liquid crystal compound.

### (First Liquid Crystal Compound)

The first liquid crystal compound is represented by formula (1).

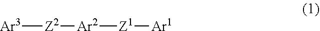

In the formula (1), each of Ar¹, Ar², and Ar³ independently represents benzene ring or naphthalene ring. Each of benzene ring or naphthalene ring represented by Ar¹ or Ar² is substituted with one to three halogen groups. The halogen groups may be the same or different from one another. For example, the halogen groups are preferably fluoro group or chloro group.

In the formula (1), benzene ring or naphthalene ring represented by Ar³ is substituted with one, two, or more aliphatic groups. The aliphatic group is aliphatic group having 1 to 10 carbon atoms, for example, alkyl group having 1 to 10 carbon atoms, alkenyl group having 2 to 10 carbon atoms, or alkynyl group having 2 to 10 carbon atoms. benzene ring or naphthalene ring represented by Ar³ may be further substituted with organic groups other than the aliphatic group.

In the formula (1), each of Z¹ and Z² independently represents a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group.

For example, in the formula (1), Ar¹ can be represented by any of formulas (2-1) to (2-8).

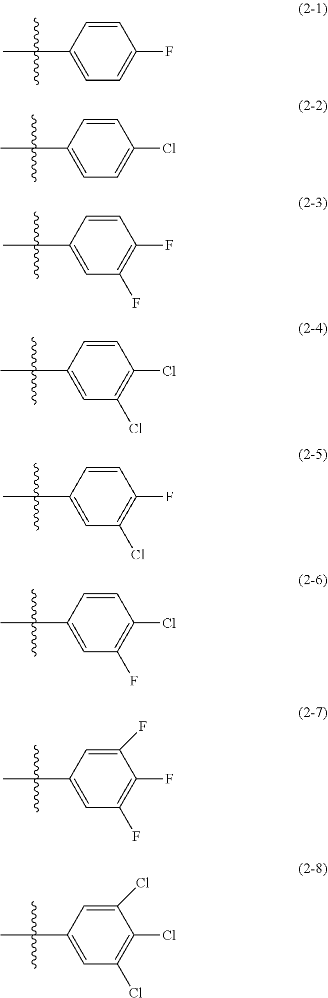

For example, in the formula (1), Ar² can be represented by any of formulas (3-1) to (3-11).

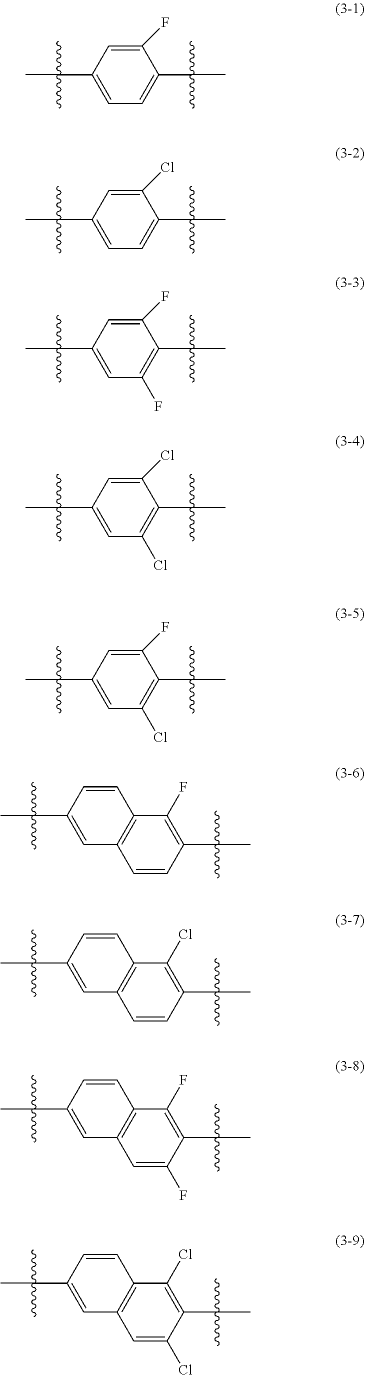

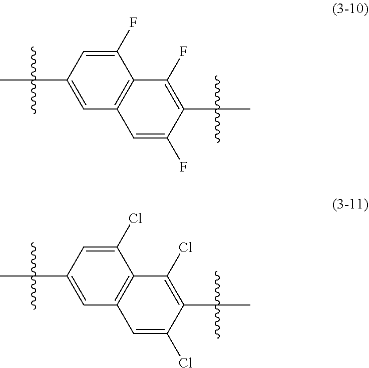 [SMILES: *c1cc(F)c2c(F)c(*)c(F)cc2c1 ; *c1cc(Cl)c2c(Cl)c(*)c(Cl)cc2c1]

For example, in the formula (1), Ar³ can be represented by formulas (4-1) or (4-2).

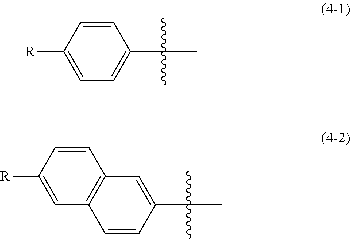

In the formulas (4-1) and (4-2), R is aliphatic group having 1 to 10 carbon atoms. For example, the aliphatic group is alkyl group having 1 to 10 carbon atoms, alkenyl group having 2 to 10 carbon atoms, or alkynyl group having 2 to 10 carbon atoms.

### (Second Liquid Crystal Compound)

The second liquid crystal compound is represented by formula (5).

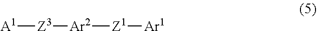

In the formula (5), each of Ar¹ and Ar² independently represents benzene ring or naphthalene ring. Each of benzene ring or naphthalene ring represented by Ar¹ or Ar² is substituted with one to three halogen groups. The halogen groups may be the same or different from one another. For example, the halogen groups are preferably fluoro group or chloro group.

In the formula (5), A¹ is 1,4-cyclohexyl group whose 4th position is substituted with an aliphatic group. The aliphatic group is aliphatic group having 1 to 10 carbon atoms, for example, alkyl group having 1 to 10 carbon atoms, alkenyl group having 2 to 10 carbon atoms, or alkynyl group having 2 to 10 carbon atoms.

In the formula (5), Z¹ is a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group.

In the formula (5), Z³ is a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, —OCO— group, or 1,4-cyclohexylene group.

For example, in the formula (5), Ar¹ can be represented by any of formulas (2-1) to (2-8).

For example, in the formula (5), Ar² can be represented by any of formulas (3-1) to (3-11).

For example, in the formula (5), A¹ can be represented by formula (6).

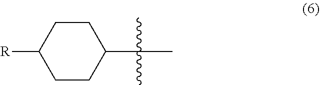

In the formula (6), R is an aliphatic group having 1 to 10 carbon atoms. For example, the aliphatic group is alkyl group having 1 to 10 carbon atoms, alkenyl group having 2 to 10 carbon atoms, or alkynyl group having 2 to 10 carbon atoms.

### [Third Liquid Crystal Compound]

The third liquid crystal compound is represented by formula (7).

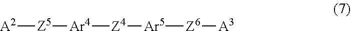

In the formula (7), each of Ar⁴ and Ar⁵ independently represents phenylene group or naphthylene group. Phenylene group or naphthylene group represented by Ar⁴ or Ar⁵ may be substituted with one, two, or more halogen groups. The halogen groups may be the same or different from one another. For example, the halogen groups are preferably fluoro group or chloro group.

In the formula (7), each of A² and A³ independently represents 1,4-cyclohexyl group whose 4th position is substituted with an aliphatic group. The aliphatic group is aliphatic group having 1 to 10 carbon atoms, for example, alkyl group having 1 to 10 carbon atoms, alkenyl group having 2 to 10 carbon atoms, or alkynyl group having 2 to 10 carbon atoms.

In the formula (7), each of Z⁴, Z⁵, and Z⁶ independently represents a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group.

For example, in the formula (7), Ar⁴ can be represented by formulas (8-1) or (8-2).

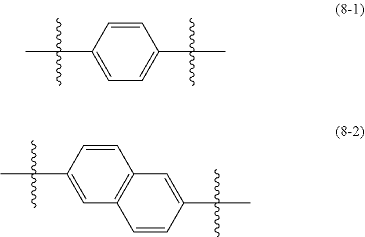 [SMILES: *c1ccc(*)cc1 ; *c1ccc2cc(*)ccc2c1]

For example, in the formula (7), Ar⁵ can be represented by any of formulas (9-1) to (9-6).

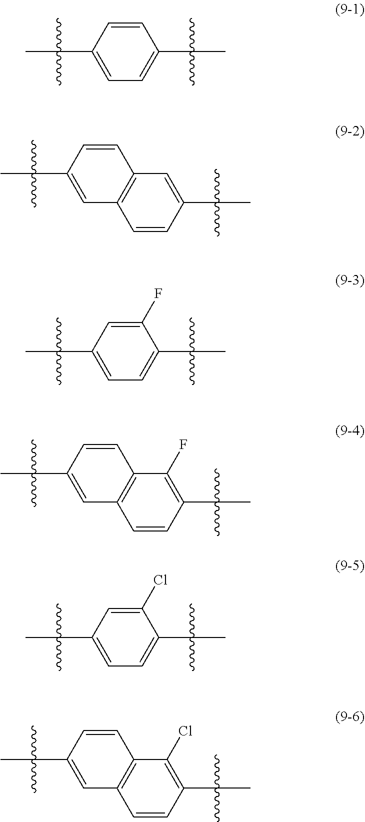 [SMILES: *c1ccc(*)cc1 ; *c1ccc2cc(*)ccc2c1 ; *c1ccc(*)c(F)c1 ; *c1ccc2c(F)c(*)ccc2c1 ; *c1ccc(*)c(Cl)c1 ; *c1ccc2c(Cl)c(*)ccc2c1]

For example, in the formula (7), A² can be represented by formula (10).

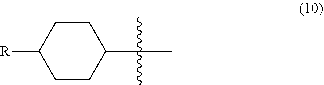

For example, in the formula (7), A³ can be represented by formula (11).

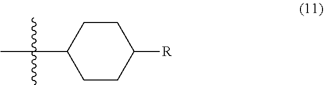

In the formulas (10) and 11, R is an aliphatic group having 1 to 10 carbon atoms. For example, the aliphatic group is alkyl group having 1 to 10 carbon atoms, alkenyl group having 2 to 10 carbon atoms, or alkynyl group having 2 to 10 carbon atoms.

The liquid crystal mixture includes at least a type of the first liquid crystal compound, at least a type of the second liquid crystal compound, and at least a type of the third liquid crystal compound. When the total weight of the first liquid crystal compound, the second liquid crystal compound, and the third liquid crystal compound in the liquid crystal mixture is assumed as 100 weight parts, the liquid crystal mixture includes each of the first liquid crystal compound, the second liquid crystal compound, and the third liquid crystal compound in an amount of, for example, 5 to 50 weight parts. The liquid crystal mixture includes, for example, one to ten types of the first liquid crystal compounds, one to five types of the second liquid crystal compounds, and one to five types of the third liquid crystal compounds.

### (Monomer Mixture)

The liquid crystal material composition includes the monomer mixture. The monomer mixture includes the first monomer compound having acryloyl group at each terminal and the second monomer compound having acryloyl group at only one terminal.

The first monomer compound is represented by formula (12).

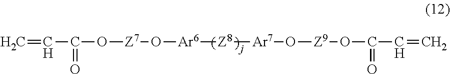

Each of Z⁷ and Z⁹ in the formula (12) independently represents alkylene group having 1 to 10 carbon atoms.

Z⁸ in the formula (12) is —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH₂CH₂OCO— group, —COOCH₂CH₂— group, —CH₂CH₂COO—, group, —OCOCH₂CH₂— group, —CH═CH— group, —C≡C— group, —CF₂O— group, —OCF₂— group, —COO— group, —OCO— group, or phenylene group.

Phenylene group represented by Z⁸ may be substituted with at least one group of alkyl group having 1 to 5 carbons, alkoxy group having 1 to 5 carbons, phenyl group, and a halogen group.

Each of Ar⁶ and Ar⁷ in the formula (12) independently represents phenylene group.

Phenylene group represented by Ar⁶ or Ar⁷ may be substituted with at least one group of alkyl group having 1 to 5 carbons, alkoxy group having 1 to 5 carbons, phenyl group, a halogen group, and a group represented by formula (13).

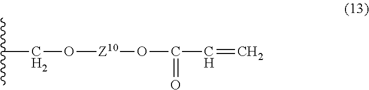

Z 10 in the formula (13) is alkylene group having 1 to 10 carbon atoms.

Z⁸, Ar⁶, and Ar⁷ in the formula (12) may be the same group or different from one another.

j in the formula (12) is 0, 1, 2, or 3.

For example, the first monomer compound is represented by any of formulas (14-1) to (14-14).

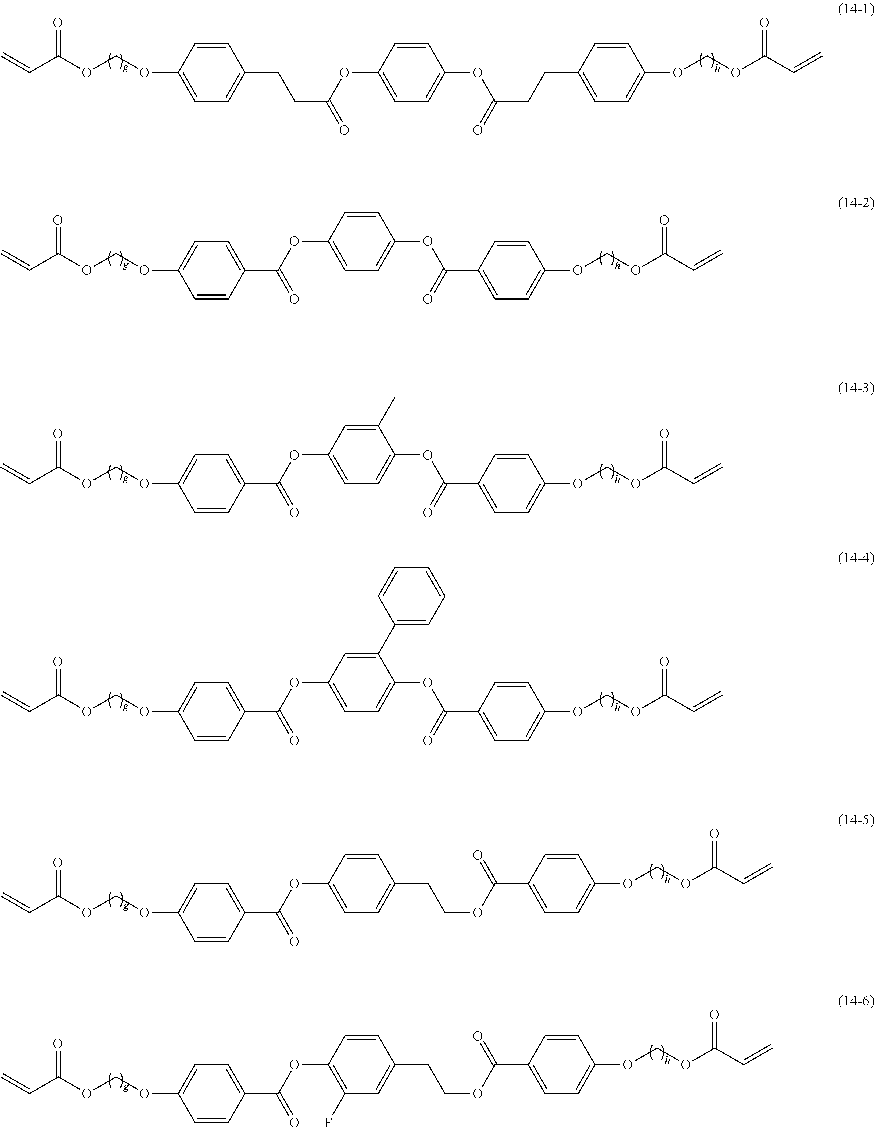

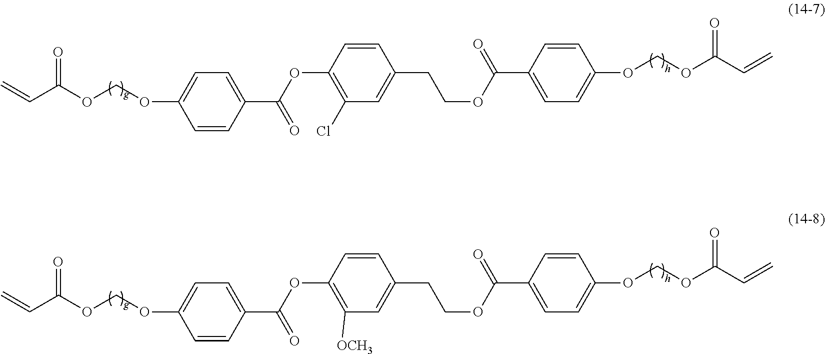

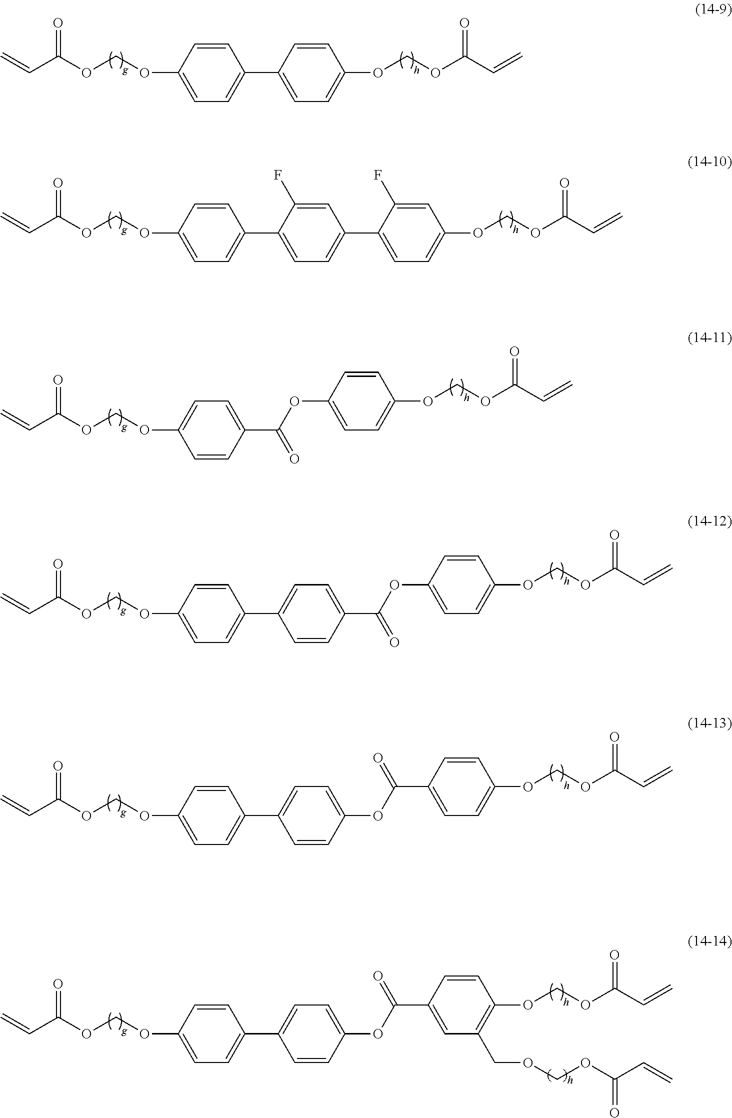

In the formulas (14-1) to (14-14), each of g and h independently represents an integer from 1 to 10.

The second monomer compound is represented by formula (15).

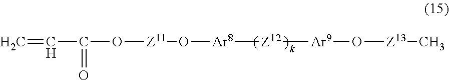

Each of Z¹¹ and Z¹³ in the formula (15) independently represents alkylene group having 1 to 10 carbon atoms.

Z¹² in the formula (15) is —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH₂CH₂OCO— group, —COOCH₂CH₂— group, —CH₂CH₂COO—, group, —OCOCH₂CH₂— group, —CH═CH— group, —C≡C— group, —CF₂O— group, —OCF₂— group, —COO— group, —OCO— group, or phenylene group.

Phenylene group represented by Z¹² may be substituted with at least one group of alkyl group having 1 to 5 carbons, alkoxy group having 1 to 5 carbons, phenyl group, and a halogen group.

Each of Ar⁸ and Ar⁹ in the formula (15) independently represents phenylene group.

Phenylene group represented by Ar⁸ or Ar⁹ may be substituted with at least one group of alkyl group having 1 to 5 carbons, alkoxy group having 1 to 5 carbons, phenyl group, a halogen group, and a group represented by formula (16).

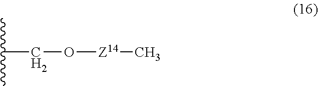

Z 14 in the formula (16) is alkylene group having 1 to 10 carbon atoms.

Z¹²s, Ar⁸s, and Ar⁹s in the formula (15) may be the same group or different from one another.

k in the formula (15) is 0, 1, 2, or 3.

For example, the second monomer compound is represented by any of formulas (17-1) to (17-14).

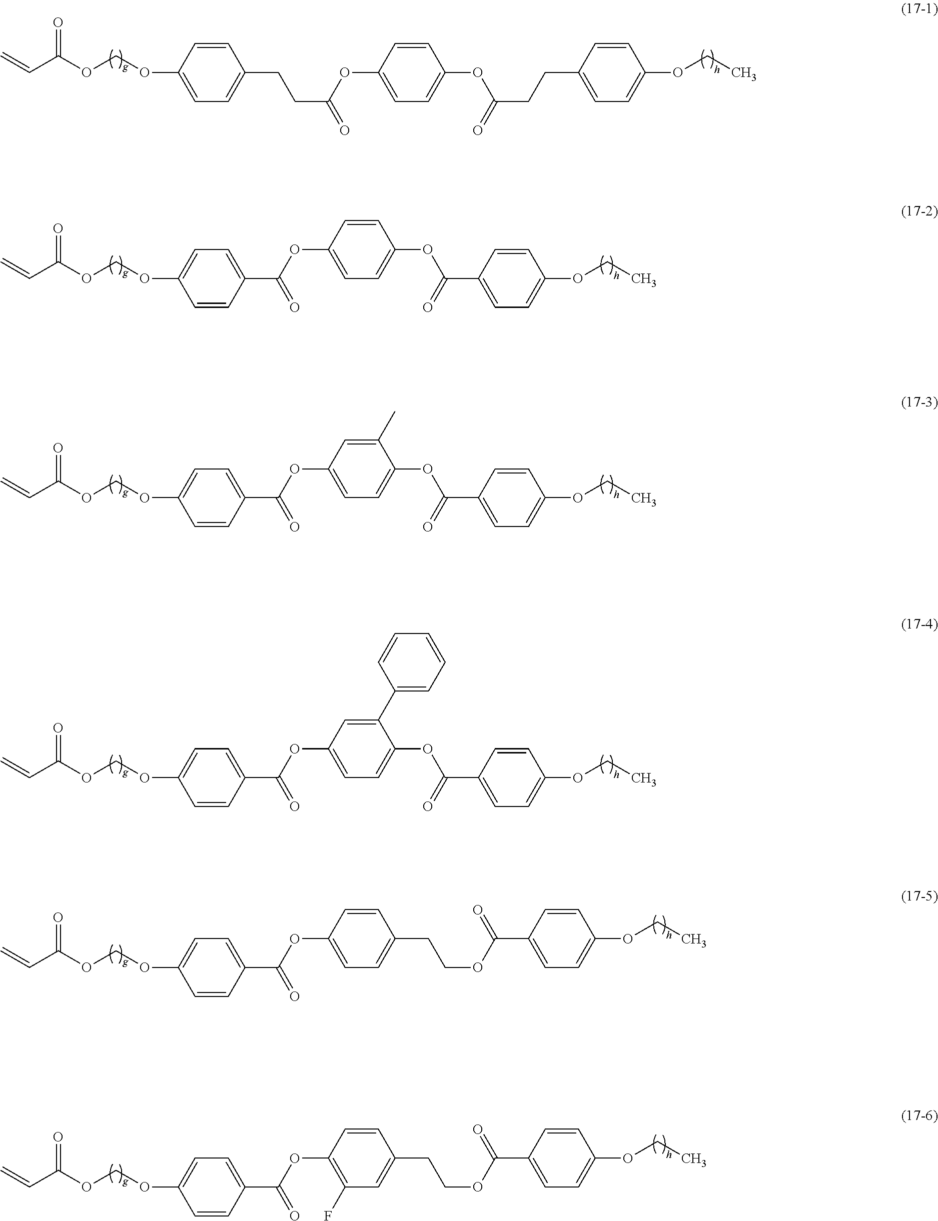

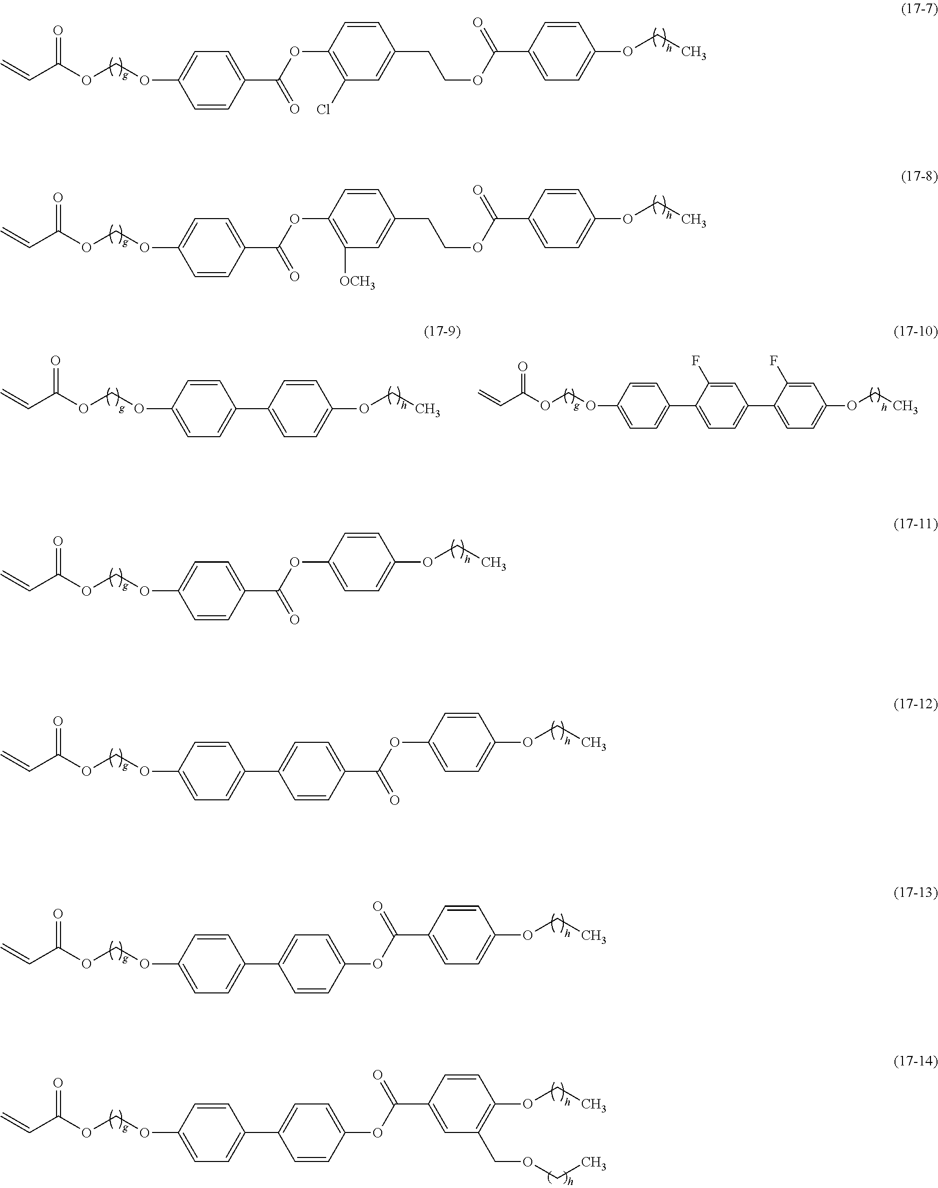

In the formulas (17-1) to (17-14), each of g and h independently represents an integer from 1 to 10.

The monomer mixture includes the first monomer compound and the second monomer compound. The monomer mixture includes one, two, or more types of the compounds represented by the formula (13) as the first monomer compound. The monomer mixture includes one, two, or more types of the compounds represented by the formula (15) as the second monomer compound. The monomer mixture preferably includes one type of the compounds represented by the formula (13) as the first monomer compound and preferably includes one type of the compounds represented by the formula (15) as the second monomer compound.

In the first monomer compound and the second monomer compound contained in the monomer mixture, Z⁷ in the formula (13) and Z¹¹ in the formula (15) are preferably the same group. Further, Z⁸ in the formula (13) and Z¹² in the formula (15) are preferably the same group. Further, Z⁹ in the formula (13) and Z¹³ in the formula (15) are preferably the same group. Further, Ar⁶ in the formula (13) and Ar⁸ in the formula (15) are preferably the same group. Further, Ar⁷ in the formula (13) and Ar⁹ in the formula (15) are preferably the same group. Further, j in the formula (13) and k in the formula (15) are preferably the same.

The combination of the first monomer compound and the second monomer compound contained in the monomer mixture preferably is the combination of the compound represented by the formula (14-1) and the compound represented by the formula (17-1), the combination of the compound represented by the formula (14-2) and the compound represented by the formula (17-2), the combination of the compound represented by the formula (14-3) and the compound represented by the formula (17-3), the combination of the compound represented by the formula (14-4) and the compound represented by the formula (17-4), the combination of the compound represented by the formula (14-5) and the compound represented by the formula (17-5), and the combination of the compound represented by the formula (14-6) and the compound represented by the formula (17-6), the combination of the compound represented by the formula (14-7) and the compound represented by the formula (17-7), the combination of the compound represented by the formula (14-8) and the compound represented by the formula (17-8), the combination of the compound represented by the formula (14-9) and the compound represented by the formula (17-9), the combination of the compound represented by the formula (14-10) and the compound represented by the formula (17-10), the combination of the compound represented by the formula (14-11), or the compound represented by the formula (17-11), the combination of the compound represented by the formula (14-12) and the compound represented by the formula (17-12), the combination of the compound represented by the formula (14-14) and the compound represented by the formula (17-13), and the combination of the compound represented by the formula (14-14) and the compound represented by the formula (17-14).

Depending on the combination of the monomer compounds contained in the monomer mixture, the compatibility between the monomer compounds may decrease. If the compatibility between the monomer compounds is low, the manufacturing of the display panel PNL described below may become complicated, for example, by the need of an additional process to make the monomer compounds compatible.

As described above, making each group represented by Z⁷, Z⁸, Z⁹, Ar⁶, and Ar⁷ in the formula (13) and each group represented by Z¹¹, Z¹², Z¹³, Ar⁸, and Ar⁹ in the formula (15) the same group can prevent decreases in the compatibility between the first monomer compound and the second monomer compound contained in the monomer mixture. Also, as described above, making j in the formula (13) and k in the formula (15) the same can prevent decreases in the compatibility between the first monomer compound and the second monomer compound contained in the monomer mixture.

In the monomer mixture, the content (mol %) of the first monomer compound is preferably higher than the content (mol %) of the second monomer compound.

As described later, in the manufacturing of the display panel PNL, the liquid crystal material composition is provided between the alignment films AL1 and AL2. At this time, the first monomer compound and the second monomer compound are aligned in the same direction as the liquid crystal mixture 32 (for example, in the first direction X) due to the alignment restriction force of the alignment film AL1 and the alignment film AL2. The polymers 31 can be obtained by polymerizing the monomer mixture containing the first monomer compound and the second monomer compound in this manner. The polymer 31 includes a polymer 31a mainly derived from the first monomer compound, and a polymer 31b mainly derived from the second monomer compound. The polymer 31a mainly derived from the first monomer compound has a structure in which each terminal of the first monomer compound subsequently undergoes bonding and the structural units derived from the first monomer compound are introduced into the main chain. For example, the polymer 31a has repeating structural units represented by formula (18).

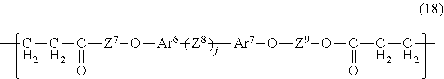

Z⁷, Z⁸, Z⁹, Ar⁶, Ar⁷, and j in the formula (18) are the same as those in the above formula (13).

The polymer 31b mainly derived from the second monomer compound has a structure in which one terminal of the second monomer compound sequentially undergoes bonding and the structural units derived from the second monomer compound are introduced into the side chain. For example, the polymer 31b has repeating structural units represented by formula (19).

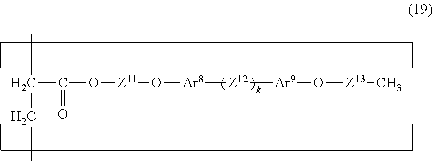

Z¹¹, Z¹², Z¹³, Ar⁸, Ar⁹, and k in the formula (19) are the same as those defined in the above formula (15).

### (Polymerization Initiator)

The liquid crystal material composition contains a polymerization initiator. For example, the polymerization initiator is a thermal polymerization initiator or a photo polymerization initiator.

The thermal polymerization initiator is a compound that generates active species when being heated to 80° C. or higher. For example, the thermal polymerization initiator is a thermal radical polymerization initiator or a thermal cationic polymerization initiator.

The thermal radical polymerization initiator contains, for example, an azo-based compound or a peroxide compound.

For example, the azo-based compound is 2,2′-azobis(isobutyronitrile), 2,2′-azobis(2-methylbutyronitrile), 2,2′-azobis(2,4-dimethylvaleronitrile), 4,4′-azobis(4-cyanovaleric acid), 2,2′-azobis(2-methylpropionate)dimethyl, 2,2′-azobis(2-methylpropionamidine)dihydrochloride or 2,2′-azobis[2-(2-imidazoline-2-yl)propane]dihydrochloride.

The peroxide compound is, for example, tert-butyl hydroperoxide, cumene hydroperoxide, di-tert-butylperoxide, dicumyl peroxide or benzoyl peroxide.

The thermal cationic polymerization initiator is, for example, dicyandiamide, cyclohexyl p-toluenesulfonate, diphenyl(methyl)sulfonium tetrafluoroborate, benzyl(4-hydroxyphenyl) methylsulfonium hexafluoroantimonate, or (4-hydroxyphenyl)methyl(2-methyl benzyl) sulfonium hexafluoroantimonate.

For example, the photo polymerization initiator is a compound that produces active species when exposed to light, such as ultraviolet rays. For example, the photo polymerization initiator is a compound that absorbs light with a wavelength of 350 nm to 380 nm and produces active species. For example, the photo polymerization initiator is the photo radical polymerization initiator, the photo cationic polymerization initiator, or the photo anionic polymerization initiator.

The photo radical polymerization initiator contains, for example, a benzophenone-based compound, an acetophenone-based compound, a benzoin-based compound, a thioxanthone-based compound or a phosphine oxide-based compound.

The benzophenone-based compound is, for example, benzophenone, 4-benzoylbenzoic acid, 2-benzoylbenzoic acid, methyl 2-benzoylbenzoate, 4,4′-bis(dimethylamino)benzophenone, 4,4′-bis(diethylamino)benzophenone, 4,4′-dichlorobenzophenone, 1,4′-dibenzoyl benzene, 4-methyl benzophenone, hydroxy benzophenone, 2,4,6-trimethyl benzophenone, 4-phenyl benzophenone, 4-methoxy-3,3′-dimethyl benzophenone, 4-benzoyl 4′-methyl diphenyl sulfide or 4,4′-carbonylbis(diperoxyphthalic acid di-tert-butyl).

The acetophenone-based compound is, for example, acetophenone, 2-hydroxy-2-methyl propiophenone, 2-hydroxy-4′-(2-hydroxyethoxy)-2-methyl propiophenone, 1-hydroxycyclohexyl phenyl ketone, 2 methyl 4′ (methylthio)-2-morpholino propiophenone, 2-benzyl-2-dimethylamino)-4′-morpholino butyrophenone, 2-isonitroso propiophenone, or 1-(4-isopropylphenyl)-2-hydroxy-2-methylpropane-1-one.

The benzoin-based compound is, for example, benzoin, benzoin methyl ether, benzoin ethyl ether, benzoin isopropyl ether, benzoin isobutyl ether, 2-phenyl-2-(p-toluene sulfonyloxy)acetophenone, 2,2-diethoxy acetophenone or 2,2-dimethoxy-2-phenyl acetophenone.

The thioxanthone-based compound is, for example, 2-chlorothioxanthone, 2,4-dichlorothioxanthone, 2-isopropyl thioxanthone or 2,4-diethyl thioxanthene-9-one.

The phosphine oxide-based compound is, for example, diphenyl(2,4,6-trimethyl benzoyl)phosphine oxide, phenyl bis(2,4,6-trimethyl benzoyl)phosphine oxide, or lithium phenyl(2,4,6-trimethyl benzoyl)phosphinate.

The photo radical polymerization initiator may be, besides the compounds listed above, (±)-camphorquinone, benzil, benzoyl methyl formate, p-anisil, 2-ethyl anthraquinone, 2,2′-bis(2-chlorophenyl)-4,4′,5,5′-tetraphenyl-1,2′-biimidazole, or 1-(9-ethyl-9H-carbazol-3-yl)ethanone 0-acetyl oxime.

The photo cation polymerization initiator contains, for example, an iodonium salt-based compound, a sulfonium salt-based compound, or an triazine-based compound.

The iodonium salt-based compound is, for example, diphenyliodonium trifluoromethanesulfonate, diphenyliodonium hexafluorophosphate, diphenyliodonium hexafluoroarsenate, bis(4-tert-butylphenyl)iodonium triflate, bis(4-tert-butylphenyl)iodonium hexafluorophosphate or 4-isopropyl-4′-methyldiphenyliodonium tetrakis(pentafluorophenyl)borate.

The sulfonium salt-based compound is, for example, cyclopropyldiphenylsulfonium tetrafluoroborate, triphenyl sulfonium bromide, triphenyl sulfonium tetrafluoroborate, tri-p-tolyl sulfonium trifluoromethanesulfonate, or tri-p-tolyl sulfonium hexafluorophosphate.

The triazine-based compound is, for example, 2-(4-methoxyphenyl)-4,6-bis(trichloromethyl)-1,3,5-triazine, 2-(1,3-benzodioxole-5-yl)-4,6-bis(trichloromethyl)-1,3,5-triazine, 2-(4-methoxystyryl)-4,6-bis(trichloromethyl)-1,3,5-triazine, 2-(3,4-dimethoxy styryl)-4,6-bis(trichloromethyl)-1,3,5-triazine, 2-[2-(furan-2-yl)vinyl]-4,6-bis(trichloromethyl)-1,3,5-triazine or 2-[2-(5-methylfuran-2-yl)vinyl]-4,6-bis(trichloromethyl)-1,3,5-triazine.

The photo cation polymerization initiator may be 4-nitrobenzenediazonium tetrafluoroborate in addition to the compounds provided above.

The photo anion polymerization initiator is, for example, 2-(9-oxoxanthene-2-yl)propionate 1,5,7-triazabicyclo[4.4.0]dec-5-ene, 2-(9-oxoxanthene-2-yl)propionate 1,5-diazabicyclo[4.3.0]non-5-ene, 2-(9-oxoxanthene-2-yl)propionate 1,8-diazabicyclo[5.4.0]undec-7-ene, acetophenone O-benzoyl oxime, cyclohexylcarbamate 2-nitrobenzyl, cyclohexylcarbamate 1, 2-bis(4-methoxyphenyl)-2-oxoethyl, or nifedipine.

Preferably, a photo polymerization initiator is used as a polymerization initiator. In this manner, the monomer mixture can be readily polymerized by irradiating the liquid crystal material composition with ultraviolet rays in the manufacturing of the display panel PNL described below.

The amount of polymerization initiators contained in the liquid crystal material composition is, for example, 0.1 to 30% by weight of the monomer mixture, preferably 1 to 20% by weight, and more preferably 5 to 15% by weight.

The present embodiment can suppress decreases in display quality in the display panel PNL.

In the display device DSP, when no voltage is applied to the liquid crystal layer LC, the alignment direction of the polymers 31 and the liquid crystal mixtures 32 is the same, and their optical axes are parallel to each other. Therefore, light beams made incident on the liquid crystal layer LC are transmitted substantially without being scattered inside the liquid crystal layer LC (the transparent state). When a voltage is applied to the liquid crystal layer LC, the alignment direction of the polymers 31 does not vary, but the alignment direction of the liquid crystal mixtures 32 varies. As a result, the optical axes of the polymers 31 and the liquid crystal mixtures 32 intersect each other. Thus, light beams made incident on the liquid crystal layer LC are scattered inside the liquid crystal layer LC (the scattering state).

If there are parts where the alignment directions of the polymers 31 and the liquid crystal mixtures 32 do not match in the display device DSP in the transparent state, the optical axes of the polymer 31 and the liquid crystal mixture 32 are not parallel to each other. This my cause undesirable scattering of light beams. Also, when the alignment of the polymer 31 is unstable, the alignment direction of polymers 31 may vary at the time of a voltage being applied to the liquid crystal layer LC. This may degrade display quality in the display panel PNL.

The monomer mixture contained in the liquid crystal material composition of the present embodiment includes the first monomer compound having acryloyl group at each terminal and the second monomer compound having acryloyl group at only one terminal. The polymer 31 derived from such a monomer mixture includes the polymer 31a derived mainly from the first monomer compound and the polymer 31b derived mainly from the second monomer compound.

The polymer 31a mainly derived from the first monomer compound has a structure in which structural units derived from the first monomer compound are introduced into the main chain, as shown in the formula (15). Each terminal of the structural units of such polymer 31a is fixed by bonding. Thus the polymer 31a has high alignment stability and can suppress the instability of the alignment of the polymer 31.

On the other hand, the polymer 31b mainly composed of the second monomer compound has a structure in which the structural units derived from the second monomer compound are introduced into the side chain, as shown in the formula (16). The side chain of such polymer 31b is flexible in structure. Thus, the polymer 31b is easily aligned in the same direction as the liquid crystal mixture 32 according to the alignment restriction force of the arrangement film AL. Thus, the alignment directions easily match. Thus, in the display device DSP in the transparent state, the optical axes of the polymers 31 and the liquid crystal mixtures 32 are prevented from not being parallel to each other.

In this manner, the present embodiment can suppress instability of the alignment of the polymer 31 and prevent the optical axes of the polymer 31 and the liquid crystal mixture 32 from not being parallel to each other. Thus, the present embodiment can suppress decreases in display quality in the display panel PNL.

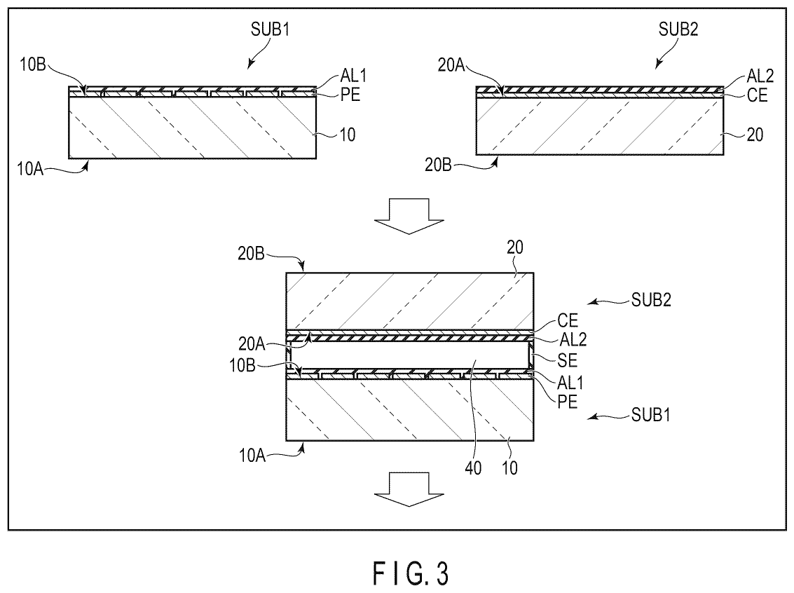

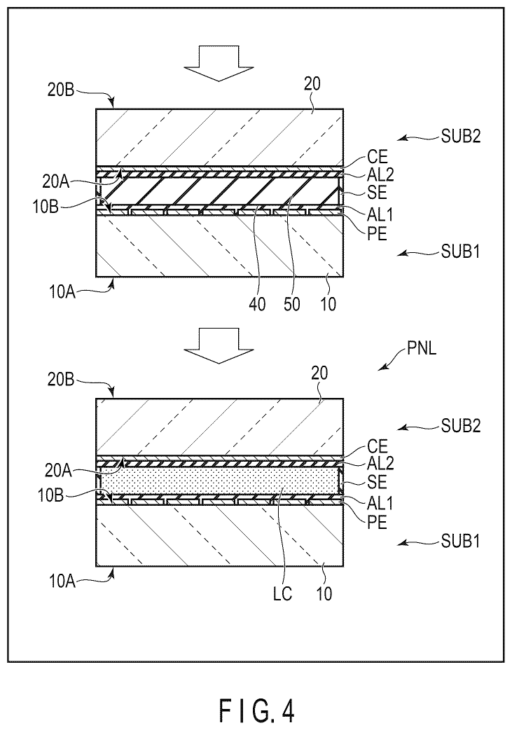

Next, an example of a manufacturing method for the display panel PNL shown in FIG. 1 will be described. FIG. 3 to FIG. 4 are schematic cross-sectional diagrams showing part of the manufacturing process for the display panel PNL. FIG. 3 and FIG. 4 omit the illustration of the insulating films 11, 12, and 13, the capacitive electrode 14, the metal line ML, the signal line S, the switching element SW, and the scanning line G.

In the manufacturing of the display panel PNL, as shown in the left side of the upper part in FIG. 3, the pixel electrode PE and the like are formed in the main surface 10B side of the transparent substrate 10, and the alignment film AL1 is formed on top of these to form the first substrate SUB1. Also, as shown in the right side of the upper part in FIG. 3, the common electrode CE and the like are formed in the main surface 20A side of the transparent substrate 20, and the alignment film AL2 is formed on top of these to form the second substrate SUB2 (process P1). The alignment films AL1 and AL2 undergo alignment treatment.

After the process P1, as shown in the lower part in FIG. 3, the first substrate SUB1 and the second substrate SUB2 are arranged with a gap 40 such that the main surface 10B and the main surface 20A face each other and are bonded together by the seal SE in the state where the gap 40 is formed (process P2).

After the process P2, as shown in the upper part in FIG. 4, a liquid crystal material composition 50 is provided in the gap 40 (process P3). Though not shown in the figures, each of the liquid crystal mixtures 32, the first monomer compound, and the second monomer compound contained in the liquid crystal material composition 50 are arranged in the same direction (for example, in the first direction X) by the alignment restriction force of the alignment films AL1 and AL2.

After the process P3, as shown in the lower part in FIG. 4, the monomer mixture contained in the liquid crystal material composition 50 provided in the gap 40 is polymerized to form the liquid crystal layer LC (process P4).

In the process P4, when the polymerization initiator contained in the liquid crystal material composition 50 is a thermal polymerization initiator, the monomer mixture is polymerized by heating the liquid crystal material composition 50 provided in the gap 40. The heating temperature is preferably 80 degrees or more, more preferably 90 degrees or more, and even more preferably 100 degrees or more.

In the process P4, when the photo polymerization initiator contained in the liquid crystal material composition 50 is a photo polymerization initiator, the monomer mixture is polymerized by irradiation of ultraviolet rays on the liquid crystal material composition 50.

Examples of the light source for ultraviolet irradiation include a metal halide lamp, a high-pressure mercury lamp, an ultrahigh-pressure mercury lamp, and UV-LED lamp. It is preferable that the wavelength of ultraviolet radiation may be in an absorption wavelength range of the photo polymerization initiators, and the ultraviolet rays of an absorption wavelength range that is not the absorption wavelength range of the liquid crystal mixture 32 contained in the liquid crystal material composition 50. When any of the metal halide lamp, the high-pressure mercury lamp, or the ultrahigh-pressure mercury lamp is used as the light source, light with which the liquid crystal material composition is irradiated is preferably light beams in which ultraviolet rays of 330 nm or less are cut, and is more preferably light beams in which ultraviolet rays of 350 nm or less are cut.

The expose amount of ultraviolet rays with which the liquid crystal material composition 50 is irradiated is preferably 10 to 10000 J/cm² and is more preferably 50 to 5000 J/cm².

The luminance of ultraviolet rays with which the liquid crystal material composition 50 is irradiated is preferably 1 to 200 mW/cm² and is more preferably 2 to 100 mW/cm².

The time period for irradiating the liquid crystal material composition 50 with ultraviolet rays is selected as appropriate according to the intensity of ultraviolet rays to be irradiated.

In one example, it is preferable to irradiate the liquid crystal material 50 with ultraviolet rays having the luminance of 2 to 100 mW/cm² in 10 to 600 seconds such that the light exposure amount is 1200 mJ/cm² to 2400 mJ/cm².

In the above example, the liquid crystal material composition 50 is injected into the gap 40 after bonding the first substrate SUB1 and the second substrate SUB2 together. The configuration is not limited to this. For example, before bonding the first substrate SUB1 and the second substrate SUB2 together, a loop-shaped seal SE may be formed on the first substrate SUB1, the liquid crystal material composition 50 may be dropped inside the area surrounded by the seal SE, the second substrate SUB2 may be stacked on the liquid crystal material composition 50, and the first substrate SUB1 and the second substrate SUB2 may be bonded together.

As described above, the present embodiment can provide a display device which can prevent degradations in display quality.

In the present embodiment, for example, the transparent substrate 10 corresponds to the first transparent substrate, and the transparent substrate 20 corresponds to the second transparent substrate.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions.

What is claimed is:

1. A liquid crystal material composition, comprising:
a liquid crystal mixture;
a polymerization initiator; and
a monomer mixture, wherein
the monomer mixture contains a first monomer compound having acryloyl group at each terminal and a second monomer compound having acryloyl group at only one terminal.

2. The liquid crystal material composition of claim 1, wherein
the first monomer compound is a compound represented by formula (1), 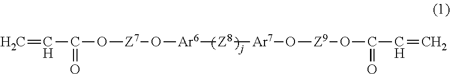
each of the Z⁷ and the Z⁹ in the formula (1) independently represents alkylene group having 1 to 10 carbon atoms,
the Z⁸ in the formula (1) is —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH₂CH₂OCO— group, —COOCH₂CH₂— group, —CH₂CH₂COO—, group, —OCOCH₂CH₂— group, —CH═CH— group, —C≡C— group, —CF₂O— group, —OCF₂— group, —COO— group, —OCO— group, or phenylene group,
phenylene group represented by the Z⁸ may be substituted with at least one group of alkyl group having 1 to 5 carbons, alkoxy group having 1 to 5 carbons, phenyl group, and a halogen group,
each of the Ar⁶ and the Ar⁷ in the formula (1) independently represents phenylene group,
phenylene group represented by the Ar⁶ or the Ar⁷ may be substituted with at least one group of alkyl group having 1 to 5 carbons, alkoxy group having 1 to 5 carbons, phenyl group, a halogen group, and a group represented by formula (2), 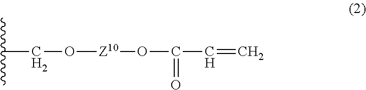
the Z 10 in the formula (2) is alkylene group having 1 to 10 carbon atoms,
the Z⁸, the Ar⁶, and the Ar⁷ in the formula (1) may be the same group or different from one another, and
the j in the formula (1) is 0, 1, 2, or 3.

3. The liquid crystal material composition of claim 1, wherein
the second monomer compound is a compound represented by formula (3), 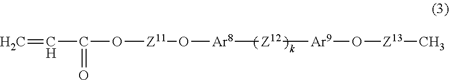
each of the Z¹¹ and the Z¹³ in the formula (3) independently represents alkylene group having 1 to 10 carbon atoms,
the Z¹² in the formula (3) is —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH₂CH₂OCO— group, —COOCH₂CH₂— group, —CH₂CH₂COO—, group, —OCOCH₂CH₂— group, —CH═CH— group, —C≡C— group, —CF₂O— group, —OCF₂— group, —COO— group, —OCO— group, or phenylene group,
phenylene group represented by the Z¹² may be substituted with at least one group of alkyl group having 1 to 5 carbons, alkoxy group having 1 to 5 carbons, phenyl group, and a halogen group,
each of the Ar⁸ and the Ar⁹ in the formula (3) independently represents phenylene group,
phenylene group represented by the Ar⁸ or the Ar⁹ may be substituted with at least one group of alkyl group having 1 to 5 carbons, alkoxy group having 1 to 5 carbons, phenyl group, a halogen group, and a group represented by formula (4), 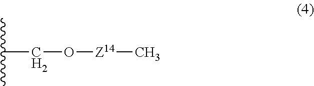
the Z 14 in the formula (4) is alkylene group having 1 to 10 carbon atoms,
the Z¹²s, the Ar⁸s, and the Ar⁹s in the formula (3) may be the same group or different from one another, and
the k in the formula (3) is 0, 1, 2, or 3.

4. The liquid crystal material composition of claim 2, wherein
the second monomer compound is a compound represented by formula (3), 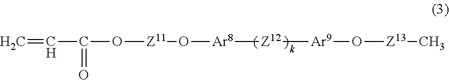
each of the Z¹¹ and the Z¹³ in the formula (3) independently represents alkylene group having 1 to 10 carbon atoms,
the Z¹² in the formula (3) is —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH₂CH₂OCO— group, —COOCH₂CH₂— group, —CH₂CH₂COO—, group, —OCOCH₂CH₂— group, —CH═CH— group, —C≡C— group, —CF₂O— group, —OCF₂— group, —COO— group, —OCO— group, or phenylene group,
phenylene group represented by the Z¹² may be substituted with at least one group of alkyl group having 1 to 5 carbons, alkoxy group having 1 to 5 carbons, phenyl group, and a halogen group,
each of the Ar⁸ and the Ar⁹ in the formula (3) independently represents phenylene group,
phenylene group represented by the Ar⁸ or the Ar⁹ may be substituted with at least one group of alkyl group having 1 to 5 carbons, alkoxy group having 1 to 5 carbons, phenyl group, a halogen group, and a group represented by formula (4), 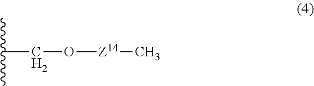
the Z 14 in the formula (4) is alkylene group having 1 to 10 carbon atoms,
the Z¹²s, the Ar⁸s, and the Ar⁹s in the formula (3) may be the same group or different from one another, and
the k in the formula (3) is 0, 1, 2, or 3.

5. The liquid crystal material composition of claim 4, wherein
in the formula (1) and the formula (3),
the Z⁷ and the Z¹¹ are the same group;
the Z⁸ and the Z¹² are the same group;
the Z⁹ and the Z¹³ are the same group;
the Ar⁶ and the Ar⁸ are the same group;
the Ar⁷ and the Ar⁹ are the same group; and
the j and the k are the same.

6. The liquid crystal material composition of claim 1, wherein
the first monomer compound is a compound represented by any of formulas (5-1) to (5-14), 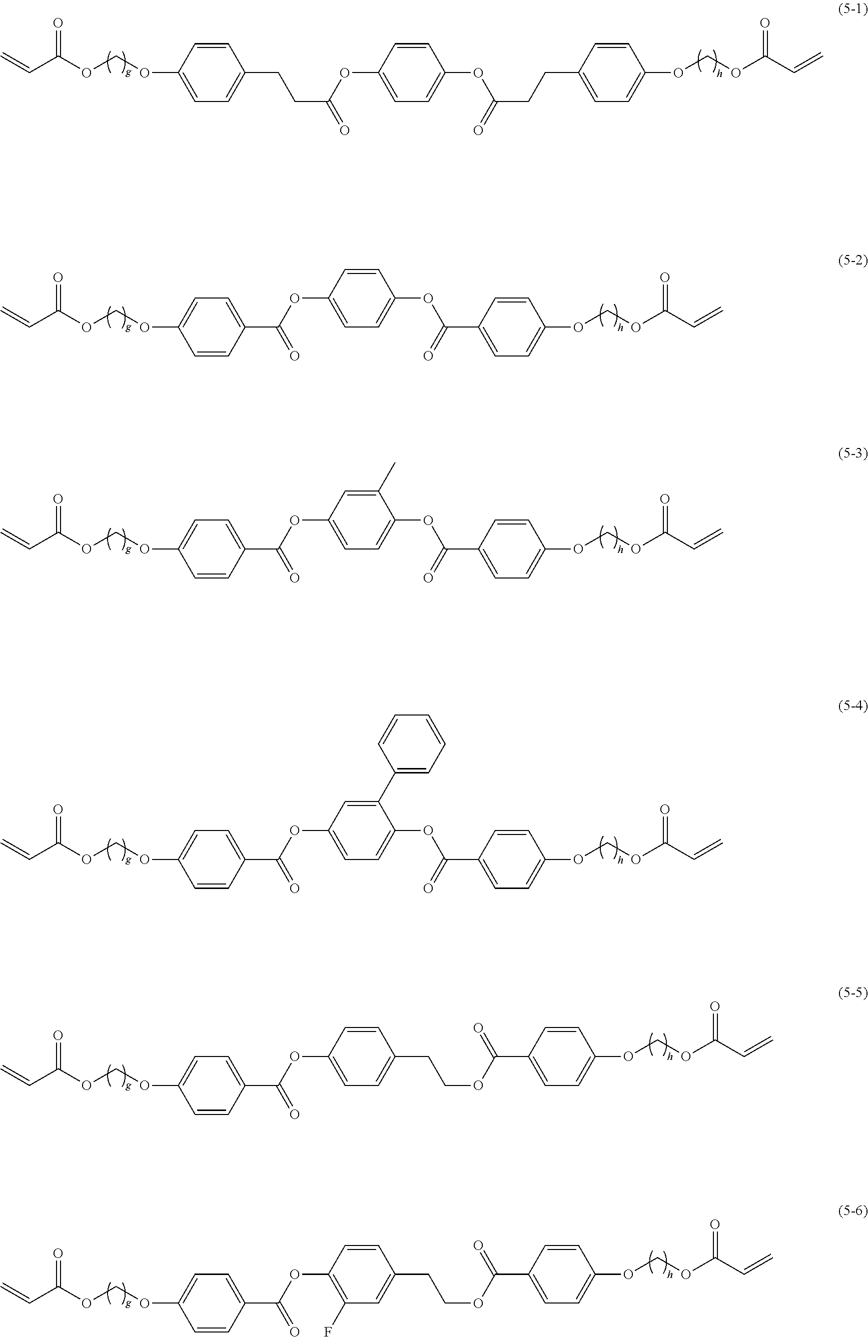 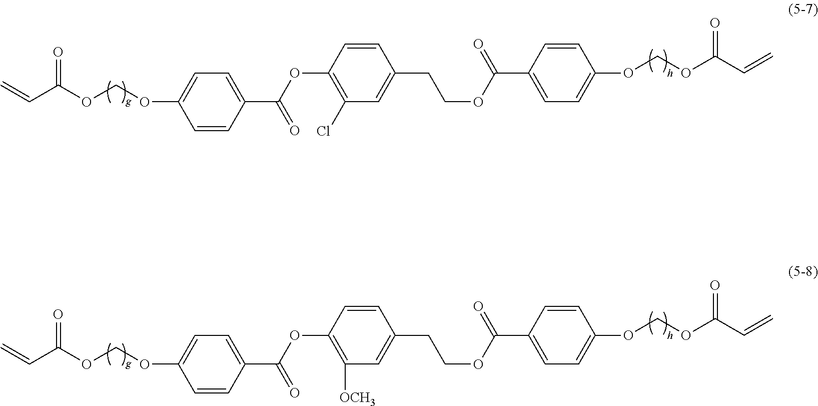 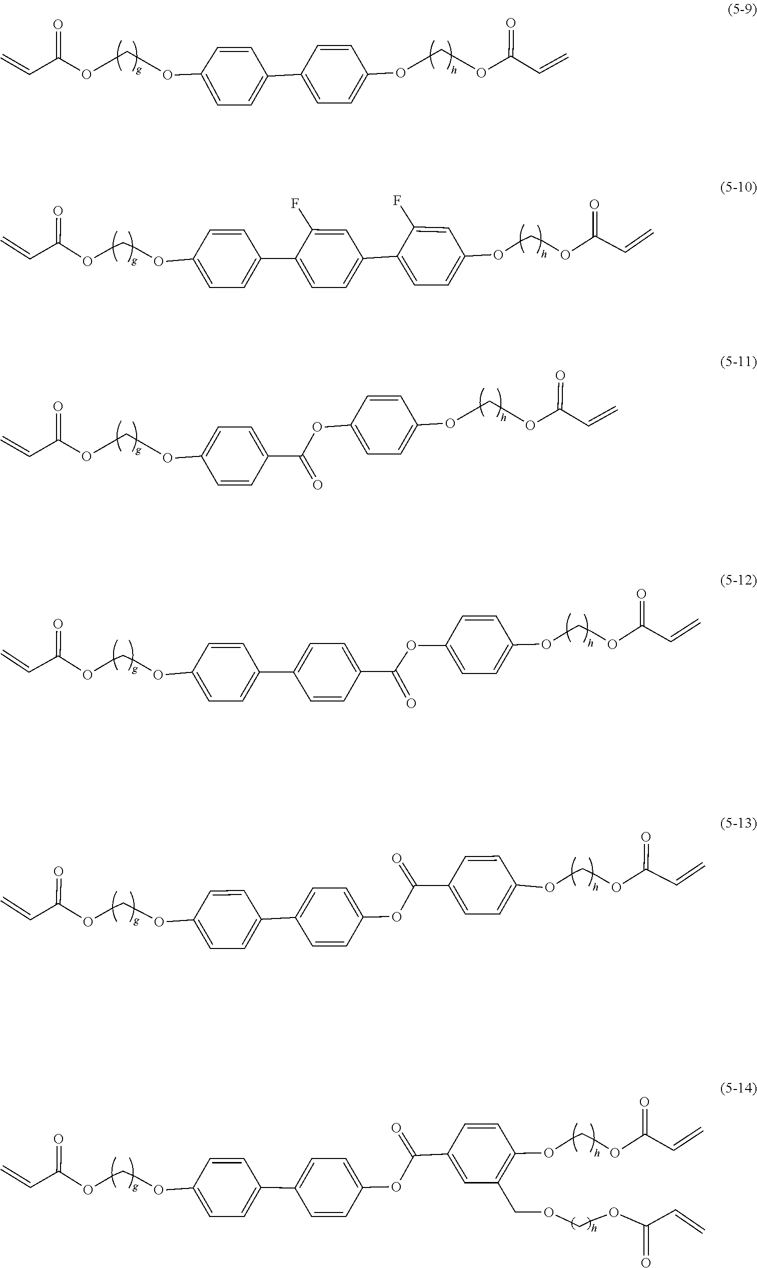
each of g and h in the formulas (5-1) to (5-14) independently represents integers of 1 to 10.

7. The liquid crystal material composition of claim 1, wherein
the second monomer compound is a compound represented by any of formulas (6-1) to (6-14), 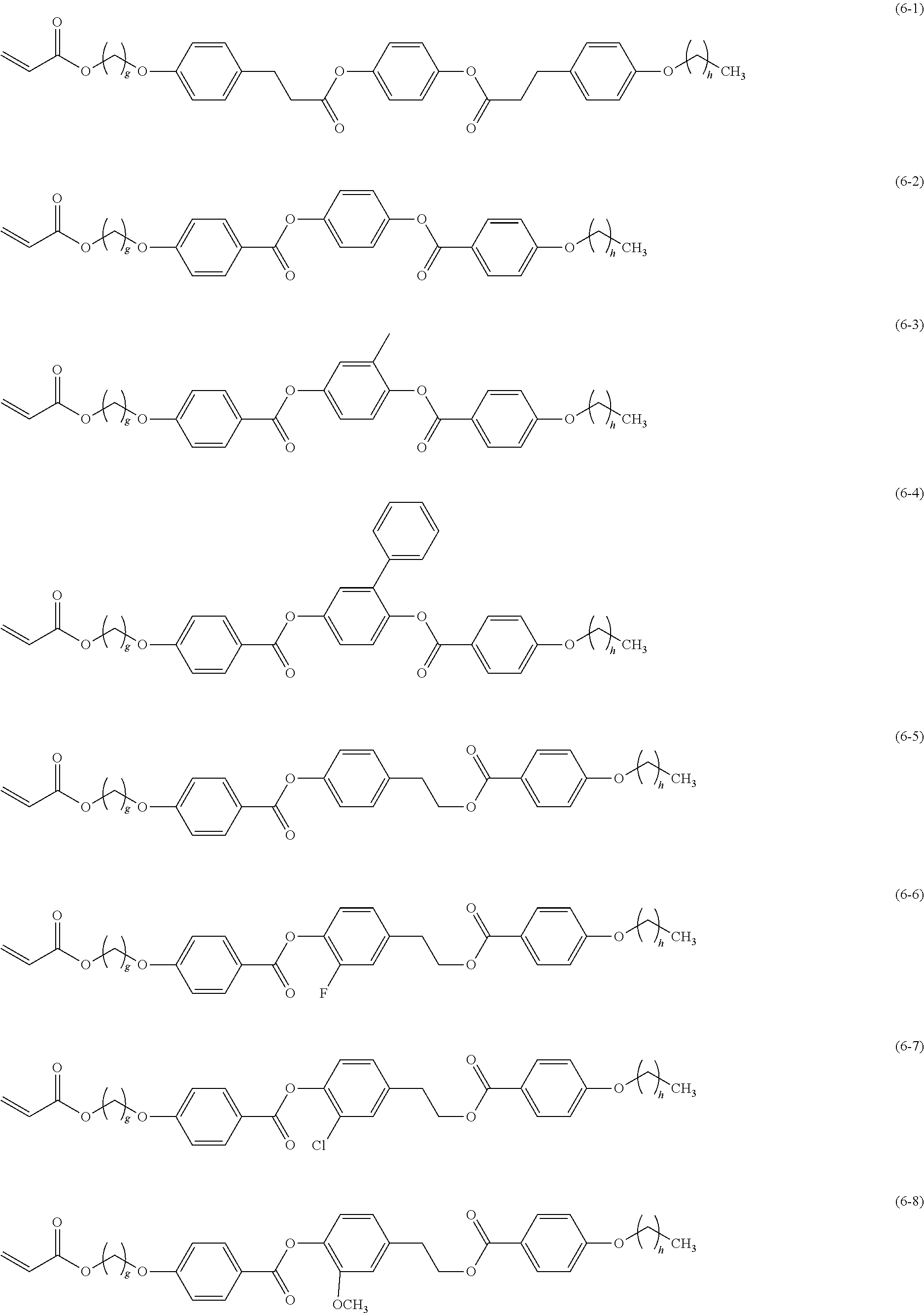 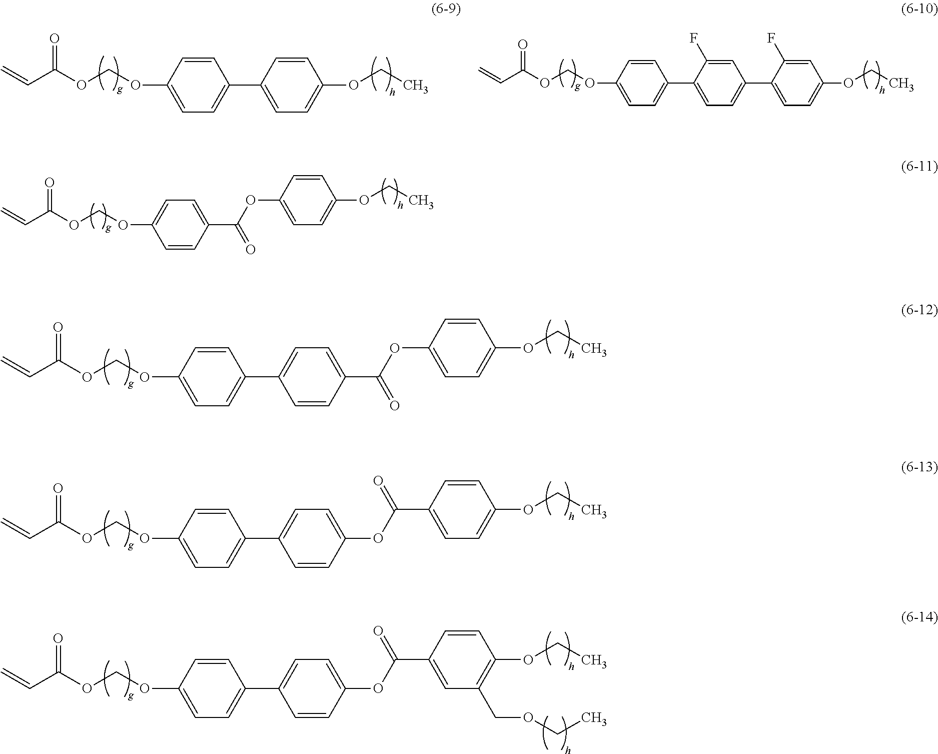
each of g and h in the formulas (6-1) to (6-14) independently represents integers of 1 to 10.

8. The liquid crystal material composition of claim 1, wherein
the first monomer compound is a compound represented by any of formulas (5-1) to (5-14), 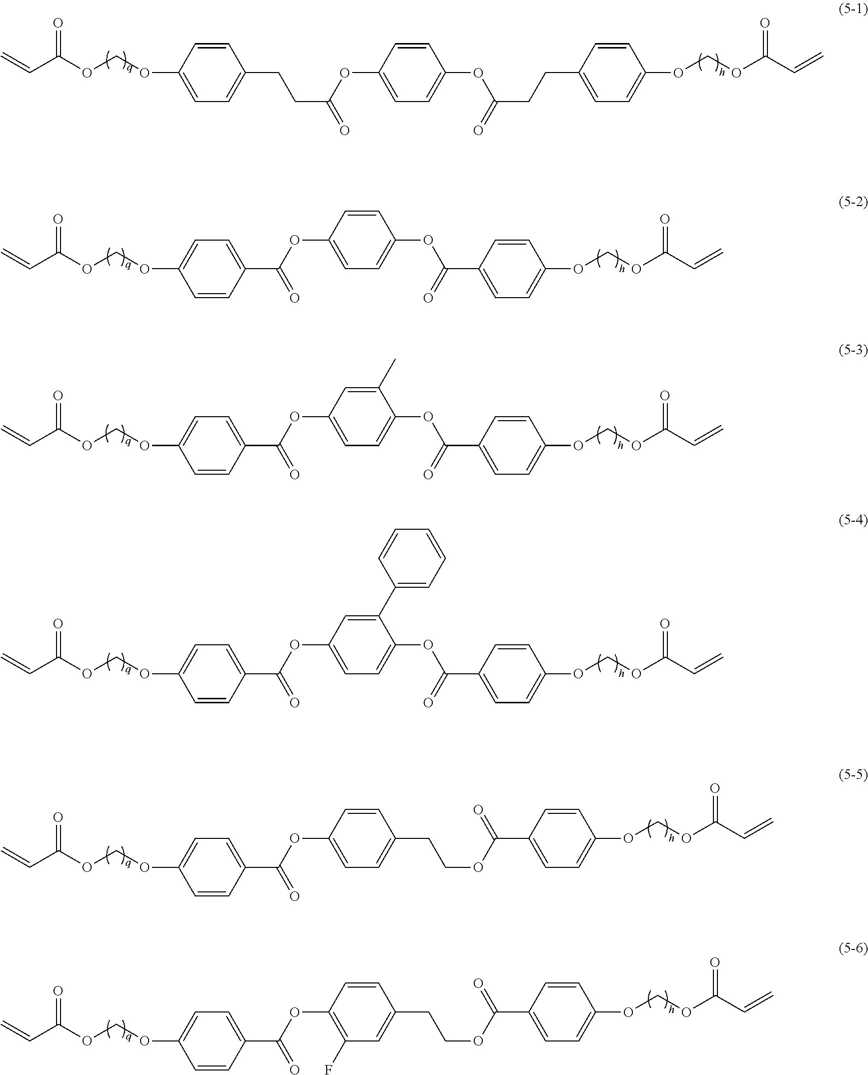 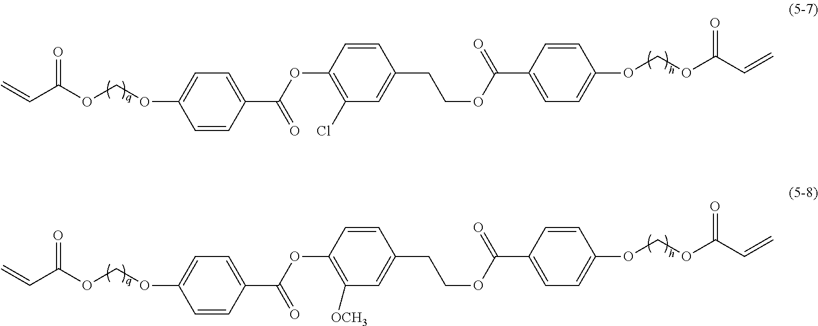 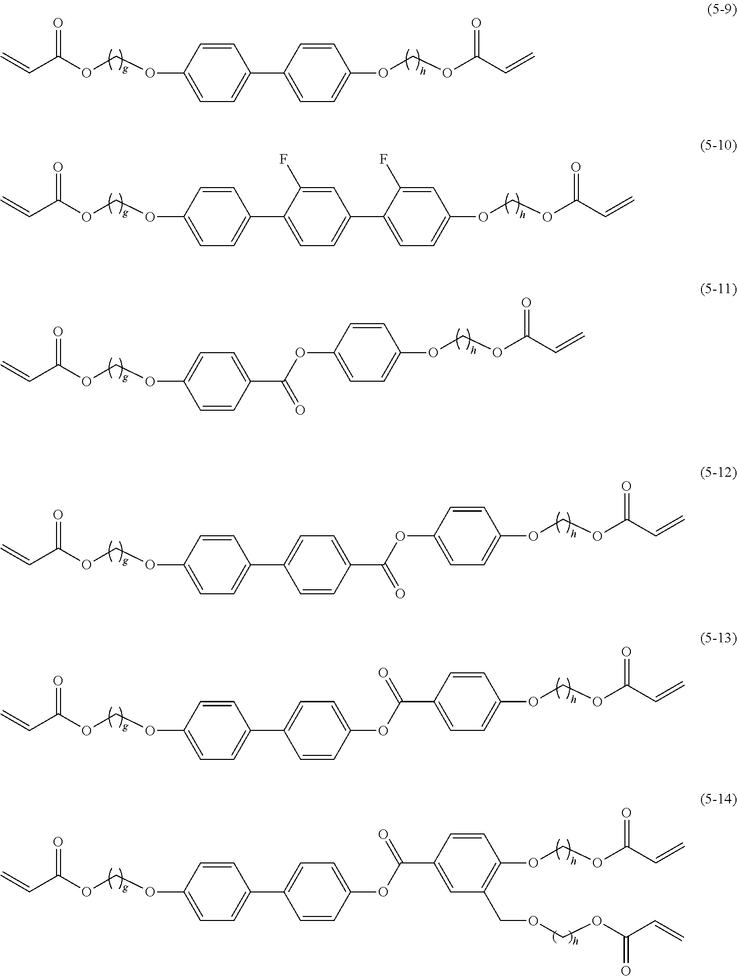
each of g and h in the formulas (5-1) to (5-14) independently represents integers of 1 to 10,
the second monomer compound is a compound represented by any of formulas (6-1) to (6-14), 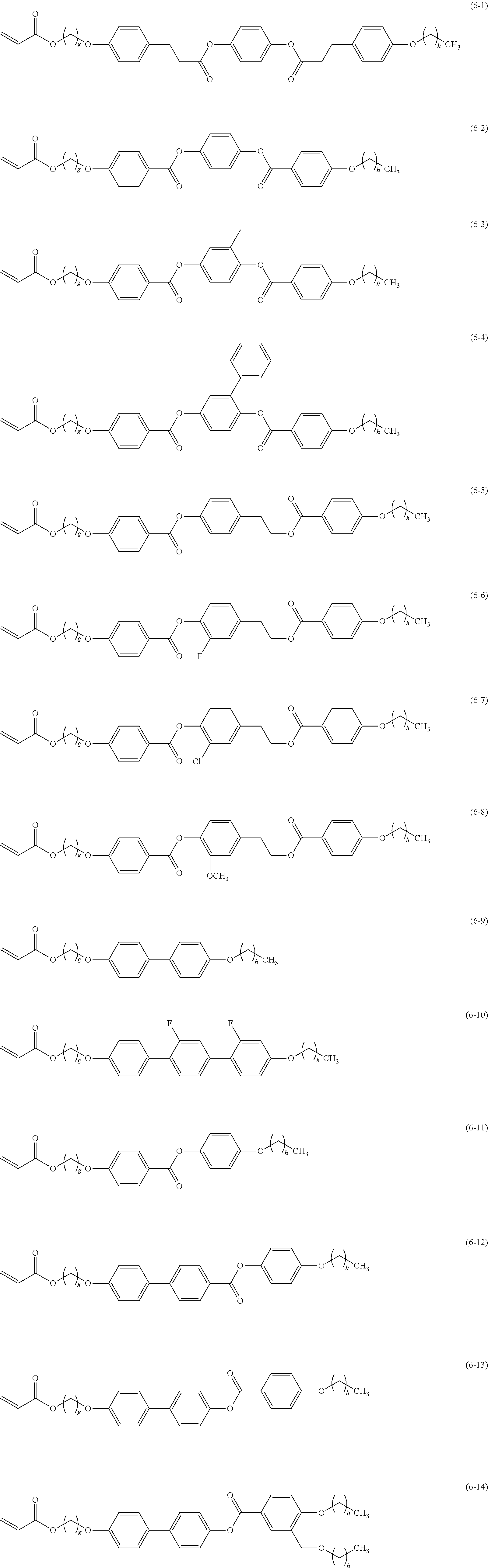
each of g and h in the formulas (6-1) to (6-14) independently represents integers of 1 to 10.

9. The liquid crystal material composition of claim 8, wherein
any of the first monomer compound and the second monomer compound is
a combination of a compound represented by formula (5-1) and a compound represented by formula (6-1),
a combination of a compound represented by formula (5-2) and a compound represented by formula (6-2),
a combination of a compound represented by formula (5-3) and a compound represented by formula (6-3),
a combination of a compound represented by formula (5-4) and a compound represented by formula (6-4),
a combination of a compound represented by formula (5-5) and a compound represented by formula (6-5),
a combination of a compound represented by formula (5-6) and a compound represented by formula (6-6),
a combination of a compound represented by formula (5-7) and a compound represented by formula (6-7),
a combination of a compound represented by formula (5-8) and a compound represented by formula (6-8),
a combination of a compound represented by formula (5-9) and a compound represented by formula (6-9),
a combination of a compound represented by formula (5-10) and a compound represented by formula (6-10),
a combination of a compound represented by formula (5-11) and a compound represented by formula (6-11),
a combination of a compound represented by formula (5-12) and a compound represented by formula (6-12),
a combination of a compound represented by formula (5-13) and a compound represented by formula (6-13), and
a combination of a compound represented by formula (5-14) and a compound represented by formula (6-14).

10. The liquid crystal material composition of claim 1, wherein
in the monomer mixture, content (mol %) of the first monomer compound is higher than content (mol %) of the second monomer compound.

11. The liquid crystal material composition of claim 1, wherein
the polymerization initiator is a photo polymerization initiator.

12. The liquid crystal material composition of claim 1, wherein
the polymerization initiator is a photo radical polymerization initiator, a photo cationic polymerization initiator, or a photo anionic polymerization initiator.

13. The liquid crystal material composition of claim 1, wherein
the polymerization initiator is contained at 0.1 to 30 weight % with respect to the monomer mixture.

14. The liquid crystal material composition of claim 1, wherein
the polymerization initiator is contained at 1 to 20 weight % with respect to the monomer mixture.

15. The liquid crystal material composition of claim 1, wherein
the polymerization initiator is contained at 5 to 15 weight % with respect to the monomer mixture.

16. The liquid crystal material composition of claim 1, wherein
the liquid crystal mixture contains a first liquid crystal compound, a second liquid crystal compound, and a third liquid crystal compound,
the first liquid crystal compound is represented by formula (7), 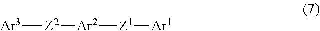
in the formula (7), each of the Ar¹, the Ar², and the Ar³ independently represents benzene ring or naphthalene ring,
each of benzene ring or naphthalene ring represented by the Ar¹ or the Ar² is substituted with one to three halogen groups,
benzene ring or naphthalene ring represented by the Ar³ is substituted with one, two, or more aliphatic groups,
each of the Z¹ and the Z² independently represents a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group,
the second liquid crystal compound is represented by formula (8), 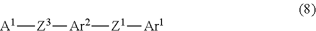
in the formula (8), each of the Ar¹ and the Ar² independently represents benzene ring or naphthalene ring,
each of benzene ring or naphthalene ring represented by the Ar¹ or the Ar² is substituted with one to three halogen groups,
the A¹ is 1,4-cyclohexyl group whose 4th position is substituted with an aliphatic group,
the Z¹ is a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group,
the Z³ is a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, —OCO— group, or 1,4-cyclohexylene group,
the third liquid crystal compound is represented by formula (9), 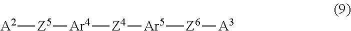
each of the Ar⁴ and the Ar⁵ in the formula (9) independently represents phenylene group or naphthylene group,
each of the A² and the A³ independently represents 1,4-cyclohexyl group whose 4th position is substituted with an aliphatic group, and
each of the Z⁴, the Z⁵, and the Z⁶ independently represents a single bond, —CH₂CH₂— group, —CH₂O— group, —OCH₂— group, —CH₂CH₂O— group, —OCH₂CH₂— group, —CH₂CH₂CH₂O— group, —OCH₂CH₂CH₂— group, —CH═CH— group, —C≡C— group, —CF₂O— group, —OCF₂— group, —COO— group, or —OCO— group.

17. The liquid crystal material composition of claim 16, wherein
in the formula (7) and the formula (8), each of benzene ring or naphthalene ring represented by the Ar¹ or the Ar² is substituted with halogen groups selected from fluoro group or chloro group.

18. The liquid crystal material composition of claim 16, wherein
when a total weight of the first liquid crystal compound, the second liquid crystal compound, and the third liquid crystal compound in the liquid crystal mixture is assumed as 100 weight parts, the liquid crystal mixture includes each of the first liquid crystal compound, the second liquid crystal compound, and the third liquid crystal compound in an amount of 5 to 50 weight parts.

19. The liquid crystal material composition of claim 16, wherein
the liquid crystal mixture includes, one to ten types of the first liquid crystal compounds, one to five types of the second liquid crystal compounds, and one to five types of the third liquid crystal compounds.

20. A display device, comprising:
a first substrate including a first transparent substrate and an alignment film provided on the first transparent substrate;
a second substrate facing the alignment film; and
a liquid crystal layer provided between the alignment film and the second substrate and containing liquid crystal mixture and polymer, and
the polymer is derived from a monomer mixture containing a first monomer compound having acryloyl group at each terminal and a second monomer compound having acryloyl group at only one terminal.
